(19) United States
(12) Patent Application Publication
(10) Pub. No.: US 2016/0270529 A1
(43) Pub. Date: Sep. 22, 2016

(54) FURNITURE LEGS CINCHING DEVICE AND METHOD

(71) Applicant: Carla Hollins, Fayetteville, GA (US)

(72) Inventor: Carla Hollins, Fayetteville, GA (US)

(21) Appl. No.: 14/663,764

(22) Filed: Mar. 20, 2015

(51) Int. Cl. A47B 87/00; A44B 17/00; A44B 13/00; A44B 11/24; F16B 2/08; A44B 11/08

(52) U.S. Cl. CPC A47B 87/00; F16B 2/08; A44B 11/08; A44B 13/00; A44B 11/24; A44B 17/0058

(57) ABSTRACT

Disclosed is a device and method for maintaining in close proximity two coordinated or matching furniture pieces by binding together at least two of the most closely adjacent legs of those furniture pieces. The main component of the device is an elastomeric ribbed strap having a variety of means of connecting one end of the strap to the opposite end. The inner surface of the strap has a ribbed texture which is coated with a tacky, friction-enhancing substance to substantially increase the gripping power of the strap. The entire strap, referred to as a “furniture cinch,” essentially comprises a resilient, slightly expandable material which may be a variety of materials, including silicon derivatives, rubber, plastic, PVC, and similar substances.

### REFERENCE TO RELATED APPLICATION

This application is a Continuation-in-Part of U.S. Published patent application Ser. No. 13/684,690 filed on Jan. 25, 2013. Claims 1 through 5 of this Continuation-in-Part application claim the benefit and the content of the previous application Ser. No. 13/684,690 by specific reference thereto as if fully appearing in the current application.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The inventive concept presented herein generally is concerned with fastening devices and methods which are utilized in situations where individual seats or sections of residential and/or commercial ensemble-type furniture pieces are designed to be placed adjacent to, and/or touching each other for a certain styling arrangement and user convenience. The fastening devices presented in this disclosure provide binding methods such that continuous, close proximity of the ensemble pieces is established, thus maintaining the coordinated and unitary appearance of the furniture or seating equipment.

(2) Description of the Related Art

The following patents and patent application publications present a range of ideas and devices that have previously been used to address the problems associated with this area of endeavor.

In U.S. Pat. No. 3,162,484 (Dec. 22, 1964; Kleffman) an invention relates to a device for use in retaining the ensemble relationship of sectional furniture. The device comprises a pair of circular ring parts formed of flexible material and dimensioned to fit over the opposed legs of the ensemble pieces.

U.S. Pat. No. 4,684,172 (Aug. 4, 1987; Lundquist). Here the inventor devises a ganging system and connector for assembling a plurality of like furniture elements such as stackable individual chairs into a stable, unitary row of seats for use in an auditorium or the like. A stylized “G”-shaped connector is used.

The inventor of U.S. Pat. No. 5,352,017 (Oct. 4, 1994; Berning) presents an arrangement of pins and open-mouthed slots to provide an apparatus for interconnecting furniture modules to form a sectional sofa in order to enable rapid and easy blind connection, while permitting both ease in disconnection and elimination of stress on the frames of adjoining sections.

U.S. Pat. No. 5,544,938 (Aug. 13, 1996; Saul et al.) is a mounting apparatus and method for releasably securing together adjacent seating sections wherein the mounting apparatus includes a bracket having a key-hole like opening formed therein and a fastener having an enlarged head and a shaft.

U.S. Pat. No. 5,957,530 (Sep. 28, 1999; Gutgsell) is a device for ganging chairs or other articles of furniture that includes a connecting body with a pivot end and a ganging end. The pivot end includes a first clip or a recess, and the ganging end includes a second clip. The first clip (recess) and the second clip releasably engage the structural frames of a first chair and second chair.

The inventor in US patent application publication #2004/0095000 A1 (May 20, 2004; Durling) designed a device comprising components of knock-down furniture and modules of sectional furniture which are equipped with interlocking brackets, connector frames, and a shelf assembly at the time of manufacture, thus providing for a method of assembling the components.

U.S. Pat. No. 7,448,689 B2 (Nov. 11, 2008; Carter et al.) is a furniture member strap system which includes a first strap having loop members at a first end and hook members at a second end and a first sewn area positioned between the loop members and the hook members. A second strap has opposed ends overlapping each other creating a looped end. The assembly joins first and second members of a furniture assembly having the first and second straps sewn to the first and second furniture members.

### BRIEF SUMMARY OF THE INVENTIVE CONCEPT

The inventive concept herein discloses a device for maintaining the close proximity of coordinated and/or similar furniture pieces that are designed and constructed to fit adjacent to each other, by binding two of the closest proximal legs of those furniture pieces to each other. The device is essentially a ribbed strap, or belt, having a means of connecting the first end of the strap to the second end, as the strap is tightly secured about the two proximal legs of separate furniture pieces. The preferred embodiment of the inventive concept comprises a roller-activated fastening mechanism with a roller-activated buckle on the first end of the ribbed strap and a metal-plated second end, which second end is dimensioned so as to allow insertion of the plated end into the buckle mechanism of the roller-activated cinch. Other fastening means of the furniture cinch include, but are not limited to, a belt buckle type fastener, a hook-and-felt type fastener, and male-female snap connectors.

The inner surface of the strap has a ribbed texture which is coated with a tacky, friction-enhancing substance to substantially increase the gripping power of the ribbed strap. The entire strap, referred to as a “furniture cinch,” essentially comprises an elastomeric, slightly expandable belt component which may be selected from a variety of materials, including silicon derivatives, rubber, plastic, PVC, and similar substances.

### BRIEF DESCRIPTION OF THE VIEWS OF THE DRAWINGS

The objects, features, and advantages of the concept presented in this application are more readily understood when referring to the accompanying drawings. The drawings, totaling eleven figures, show the basic functions of various embodiments and methods. In the several figures, like reference numbers are used in each figure to correspond to the same component as may be depicted in other figures.

FIG. 1 shows a lengthwise view of the underside of a roller-adjusted furniture cinch, including the ribbed interior surface, the underside of the buckle, and further, a side view of the mouth, or opening, of the buckle.

FIG. 1(a) is a perspective view of an L-clamp, being a component of the roller-adjusted furniture cinch.

FIG. 1(b) depicts a direct head-on view of the narrow member of the L-clamp, particularly showing the symmetrically-arranged teeth of the narrow member.

FIG. 1(c) presents two views, first a direct head-on view of the wide member of the L-clamp, looking directly at the pointed ends of the teeth, and secondly, a side view of the L-clamp, looking co-axially along the axles of the L-clamp.

FIG. 2 depicts a side view of the roller-adjusted furniture cinch depicted in FIG. 1, further depicting a profile of the buckle outer face buckle underside, and a profile view of the ribs of the roller-adjusted furniture cinch.

FIG. 3 displays two closely-spaced sectional furniture pieces of an ensemble-type furniture combination.

FIG. 4 illustrates the two sectional furniture pieces of FIG. 3 joined together at adjacent legs by a furniture cinch.

FIG. 5 is a close-up view of the two adjacent legs of the two sectional furniture pieces of FIG. 4.

FIG. 6 is an upward-looking view of both bottoms of the two sectional furniture pieces of FIG. 4, with their adjacent legs having been joined by two separate furniture cinches.

FIG. 7 illustrates an embodiment of the inventive concept, having a fastening mechanism comprising a belted buckle-type furniture cinch.

FIG. 8 illustrates an embodiment of the furniture cinch, having a fastening arrangement comprising a hook-and-felt type mechanism.

### DETAILED DESCRIPTION OF THE INVENTIVE CONCEPT

The objects, features, and advantages of the concept presented in this application are more readily understood when referring to the accompanying drawings. The drawings, totaling eleven figures, show the basic functions of various embodiments and methods. In the several figures, like reference numbers are used in each figure to correspond to the same component as may be depicted in other figures.

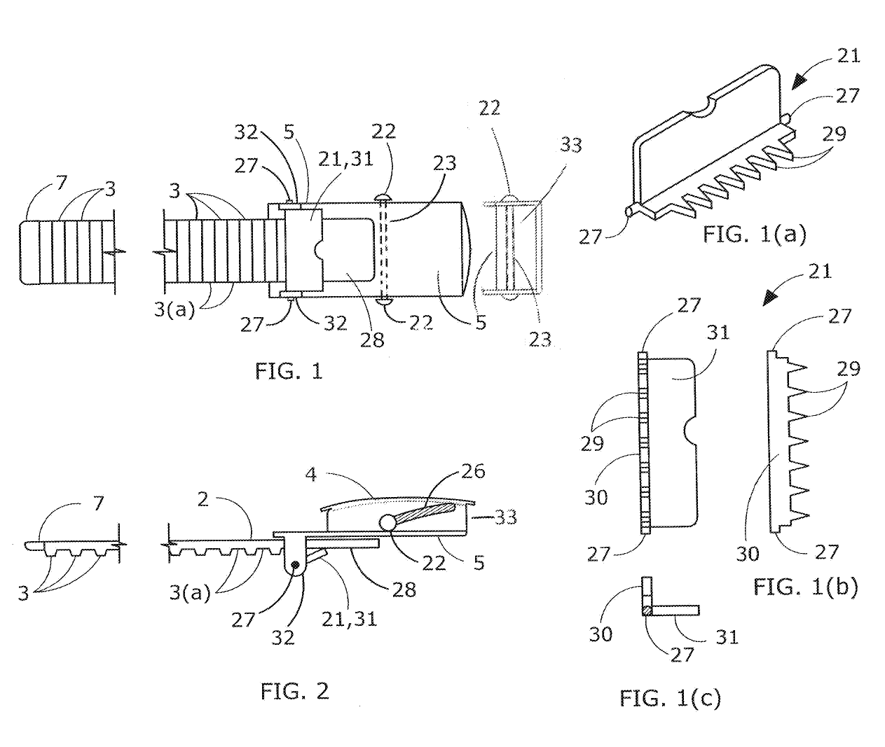

The discussion of the present inventive concept will be initiated with FIG. 1, where there is illustrated a segmented, lengthwise view of the underside of the preferred embodiment, which is a roller-adjusted furniture cinch 1. In particular, there is shown the regularly-spaced ribs 3, separated by grooves 3(a) on the interior surface of the roller-adjusted furniture cinch 1 and the underside 5 of a metal buckle of the roller-adjusted furniture cinch 1. The roller-adjusted furniture cinch 1 is shown having a first end terminating in a metal-plated tip 7, and an un-plated second end 28. The metal-plated tip 7 is attached to the first end of said strap by means of a crimping tool.

When not in use, the roller-adjusted furniture cinch 1 is essentially as shown in FIG. 1, with its second end 28 held in place abutting the buckle underside 5 by means of grasping tension imposed by the teeth 29 of an L-clamp 21. The L-clamp 21 is shown in more detail in FIG. 1(a). FIG. 1(b) and FIG. 1(c). The L-clamp 21 comprises a wide member 31 and a narrow member 30, both members being orthogonally joined together forming a junction at which two identical co-axial axles 27 protrude from both sides of the L-clamp 21. The teeth 29 of the L-clamp 21 are constructed at the edge of the narrow member 30 of the L-clamp 21. The axles 27 of the L-clamp 21 are placed into a hole in each of two flanges 32 integrally molded on both sides of the buckle underside 5. The second end 28 of the roller-adjusted cinch 1 is held in place by means of the L-clamp 21 being rotated about the two axles 27, thereby forcing the teeth 29 of the L-clamp 21 to effectively and securely grasp the surface of the second end 28 of the roller-adjusted cinch 1. The optimum length in all embodiments of the furniture cinch is a range between 15 inches and 24 inches.

FIG. 2 illustrates a side view of the roller-adjusted furniture cinch 1 shown in FIG. 1. FIG. 2 further shows a profile of the buckle outer face 4, buckle underside 5, the regularly-spaced ribs 3, and parallel grooves 3(a) of the roller-adjusted furniture cinch 1. The second end 28 of the roller-adjusted furniture cinch 1 is shown being clasped by the teeth 29 of the wide member 31 of the L-clamp 21 segment.

When the roller-adjusted furniture cinch 1 is operated, the plated tip 7, which is affixed to the second end 28 of the roller-adjusted cinch 1 is inserted into an opening, or mouth, 33 between the buckle outer face 4 and the buckle underside 5. The plated tip 7, is then placed underneath a cylindrical roller 23, which roller 23 is allowed to move freely back-and-forth within the confines of an elliptical track 26. Roller heads 22 on each end of the cylindrical roller 23 assist in maintaining the cylindrical roller 23 within the track 26. The roller 23 is of a length approximately equal to the width of the buckle outer face 4, with the roller heads 22 oriented on the outer sides of the buckle face 4.

Once the plated tip 7, along with the first end of the roller-adjusted cinch 1 are placed in position, the roller-adjusted cinch 1 takes the configuration of a loop, with the ribs 3 of the roller-adjusted cinch 1 oriented within the inner circumference of the loop. A user may then tighten the roller-adjusted cinch 1 so as to establish the desired degree of tension around an object, particularly in the case of two adjacent legs of separate furniture pieces. The tightening operation is performed by a user grasping both roller heads 22 and performing a sliding movement of both roller heads 22, thereby causing the cylindrical roller 23 to move within the track 26 and toward the L-clamp 21. The sliding movement of the cylindrical roller 23 necessarily and simultaneously imparts a friction-enhanced pressure against the surface of the second end 28 of the roller-adjusted cinch 1. The friction-enhanced pressure prevents loosening of the loop formed by the roller-adjusted cinch 1. In this manner two adjacent legs of adjacent furniture pieces in an ensemble may be held together and the two furniture pieces are prevented from separating.

The main body length of the furniture cinch 1, in its preferred embodiment is constructed from an elastomeric material, which may be selected from a variety of sources, including silicon derivatives, rubber, plastic, PVC, and similar substances.

It is also pointed out that, with the roller-adjusted cinch 1 fastening mechanism, it is not required that the first end of the roller-adjusted furniture cinch 1 comprise a plated tip 7. The first end will function just as effectively if constructed of the same material shaped as a square, rounded, or pointed end. Other forms of fastening the opposite ends of the furniture cinch 1 may comprise a hook-and-felt fastening mechanism 24, a belt buckle-type fastener 19, snap fasteners, press studs, ratchets, and other means of connection.

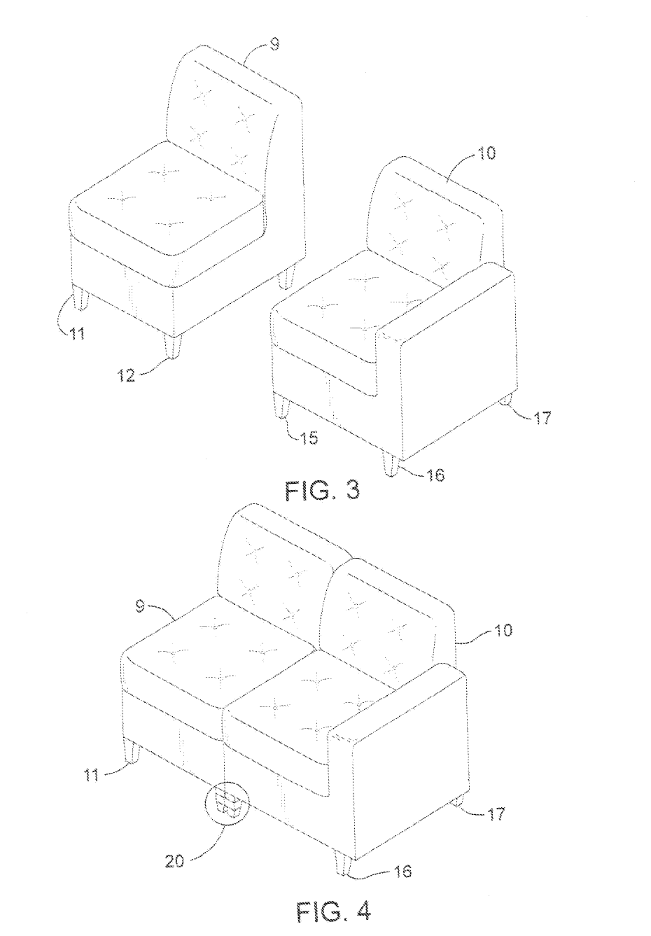

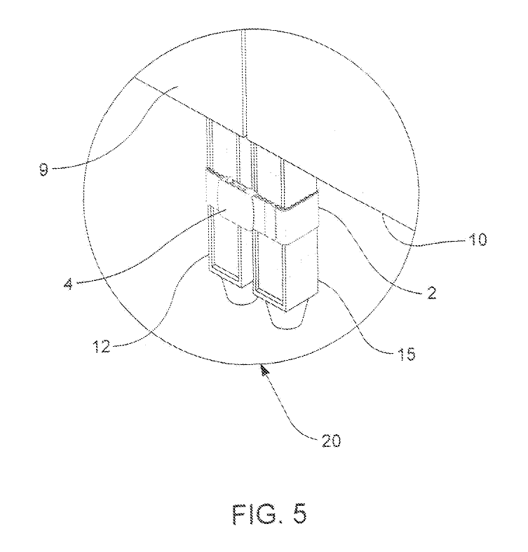

FIG. 3 depicts two similar pieces of ensemble-type furniture, being upholstered chairs, 9, 10 spaced apart. There is further shown the front legs 11, 12, 15, and 16 of the two chairs. FIG. 4 illustrates the two chairs 9, 10 placed proximate one another, causing two of the front legs 12, 15, to be substantially adjacent one another, as shown in the inset 20. In FIG. 5, an enlarged view of inset 20 illustrates the outer surface 2 of a roller-adjusted furniture cinch 1, by means of the components of the buckle outer face 4, fastened about the two front legs 12, 15 by means of a tightening of the buckle mechanism of the roller-adjusted furniture cinch 1. The inner ribs 3 of the furniture cinch (not in view) consequently generate an amount of gripping force about the two furniture legs 12, 15, thereby providing a secure cinching. The buckle outer face 4 of the furniture cinch 1 has been closed and tightened upon the furniture cinch 1 after insertion of the plated tip 7, with the end result being a curtailing any separation of the two chairs 9, 10, caused by normal seating use or unexpected jostling of either chair.

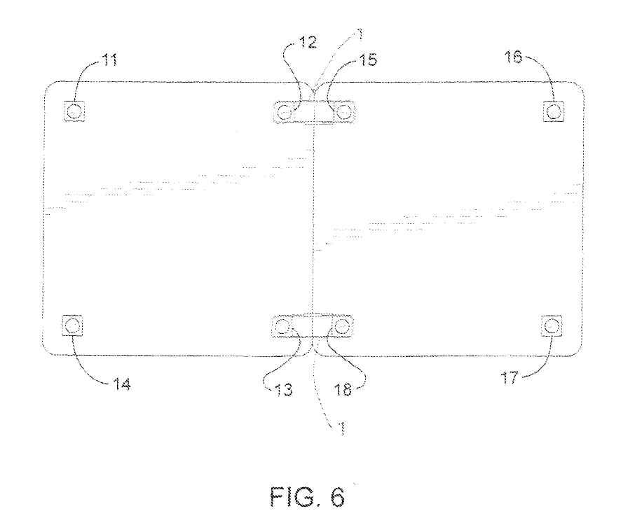

FIG. 6 illustrates an underside view of the aforesaid two chairs 9, 10 having been placed in close proximity. In the view shown in FIG. 6, both the adjacent front legs 12, 15, and adjacent rear legs 13, 18 are secured by two separate roller-adjusted furniture cinches 1. The two roller-adjusted furniture cinches 1 thereby provide enhanced stability and a connected condition of the two chairs in their side-by-side arrangement.

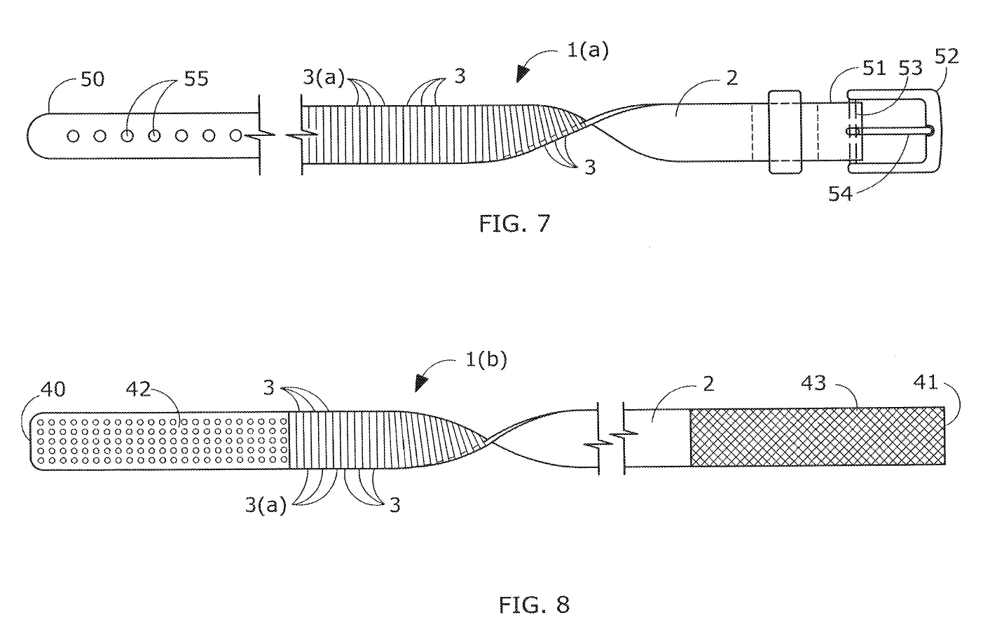

FIG. 7 illustrates a segmented, lengthwise view of the underside and exterior side of a belt-buckled furniture cinch 19. A first end 50 of the belt-buckled furniture cinch 19 comprises regularly-spaced holes 55 which transition, the holes 55 being of a diameter approximately corresponding to the diameter of a prong 54, which is a component working in conjunction with the frame 52 and bar 53 attached to the second end 51 of the belt-buckled furniture cinch 19. The belt-buckled furniture cinch 19 is displayed with one longitudinally-oriented twist, thereby displaying the regularly-spaced ribs 3 and parallel grooves 3(a) on the interior surface of the belt-buckled furniture cinch 19. Also shown is a retainer loop 56 for retention of the first end 50 of the belt-buckled furniture cinch 19 as necessary, and the outer surface 2 of the belt-buckled furniture cinch 19.

FIG. 8 illustrates a segmented, lengthwise view of the underside and outer surface 2 of a hook-and-felt furniture cinch 24. A first end 40 of the hook-and-felt furniture cinch 24 comprises the “hook” component 42 of the fastening mechanism while the second end 41 comprises “felt” component of the fastening mechanism. The hook-and-felt furniture cinch 24 is displayed with one longitudinally-oriented twist, thereby displaying the regularly-spaced ribs 3, parallel grooves 3(a) on the interior surface, and also the outer surface 2 of the hook-and-felt furniture cinch 24.

While preferred embodiments of the present inventive concept have been shown and disclosed herein, it will be obvious to those persons skilled in the art that such embodiments are presented by way of example only and not as a limitation to the scope of the inventive concept. Numerous variations, changes, and substitutions may occur or be suggested to those skilled in the art without departing from the intent, scope, and totality of the inventive concept. Such variations, changes, and substitutions may involve other features which are already known per se and which may be used instead of, or in addition to features already disclosed herein. Accordingly, it is intended that this inventive concept not be limited by the scope of the accompanying claims.

What is claimed is:

1. Where two individual pieces or sections of residential or commercial ensemble-type furniture are conceptually and functionally designed and manufactured to be placed closely adjacent to each other such that continuous, close proximity of the two furniture pieces is desired, thus maintaining the coordinated and unitary appearance and functional convenience of the adjacent furniture pieces, a strap-like device for the secure binding together of at least two of the most closely adjacent legs of the two furniture pieces is provided, the device comprising:
a first member comprising a primarily longitudinal elastomeric strap with a length in the range of 15 inches to 24 inches, and having a first end, a second end, an outer surface, and an interior surface, wherein said interior surface further comprises (a) regularly-spaced, parallel ribs oriented orthogonally crosswise to the length of said strap, and (b) a tacky substance coating the surface of said ribs:
a second member comprising a male fastening means attached to the first end of said strap; and
a third member comprising a female fastening means attached to the second end of said strap, whereby said female fastening means corresponds to the structure of said male fastening means.

2. Where two individual pieces or sections of residential or commercial ensemble-type furniture are conceptually and functionally designed and manufactured to be placed closely adjacent to each other such that continuous, close proximity of the two furniture pieces is desired, thus maintaining the coordinated and unitary appearance and functional convenience of the adjacent furniture pieces, a strap-like device for the secure binding together of at least two of the most closely adjacent legs of the two furniture pieces is provided, the device comprising:
a first member comprising a primarily longitudinal elastomeric strap comprising a length in the range of 15 inches to 24 inches and having a first end, a second end, an outer surface, and an interior surface, wherein said interior surface further comprises (a) regularly-spaced, parallel ribs oriented orthogonally crosswise to the length of said strap, and (b) a tacky substance coating the exterior of said ribs;
a second member comprising a metal-plated clamp attached to the first end of said strap; and
a third member comprising a metal buckle apparatus having an outer face and an underside, joined by parallel side members, each side member having an elliptical-shaped track housing a cylindrical roller slidably movable within said track, further, said underside having two flanges orthogonally and integrally molded on both sides of the buckle underside, each of said flanges further having an aperture, an L-clamp comprising a wide member and a narrow member, said narrow member having a series of teeth protruding from its edge, wherein the wide member and narrow member being orthogonally joined together, form a junction at which two identical co-axial axles protrude from both sides of the L-clamp, the two axles of a diameter corresponding to the apertures of said L-clamp whereby said L-clamp is rotated about its axes forcing the teeth of the L-clamp to forcibly grip the second end, causing retention of the second end of said elastomeric strap within the L-clamp, and, upon insertion of the first end of said strap between the buckle outer face and underside, the said cylindrical roller is moved within the confines of said track in the direction of said L-clamp, thereby exerting a frictional force against the first end of said strap, causing a resultant clamping of the first end and a consequential firm cinching of the entirety of the elastomeric strap around the adjacent two legs of said furniture pieces.

3. A furniture cinching strap device as in claim 1 wherein the male fastening means comprises the hook component of a hook-and-felt fastening mechanism and the female fastening means comprises the felt component of a hook-and-felt fastening mechanism.

4. The furniture cinching strap device as in claim 1 wherein the male fastening means comprises a belt buckle consisting of a prong, frame, and bar constructed on the first end of said strap, and the female fastening means comprises regularly-spaced, center-aligned holes through the second end of said strap.

5. The furniture cinching strap device as in claim 1 wherein the male fastening means comprises a plurality of regularly-spaced male snap fasteners embedded in the first end of said furniture cinching device, and the female fastening means comprises regularly-spaced, corresponding female snap fasteners embedded in, and regularly spaced in the second end of said strap in conformance with the spacing of said male snap fasteners.

6. Where two individual pieces or sections of residential or commercial ensemble-type furniture are conceptually and functionally designed and manufactured to be placed closely adjacent to each other such that continuous, close proximity of the two furniture pieces is desired, thus maintaining the coordinated and unitary appearance and functional convenience of the adjacent furniture pieces, a method for the secure binding together of at least two the most closely adjacent legs of the two furniture pieces is provided, the method comprising the steps of:
providing a primarily longitudinal elastomeric strap comprising a length between 15 inches and 24 inches, and having a first end with a metal-plated clamp, a second end, an outer surface, and an interior surface, wherein said interior surface further comprises (a) regularly-spaced, parallel ribs oriented orthogonally crosswise to the length of said strap, and (b) a tacky substance coating the exterior of said ribs;
providing a metal buckle apparatus having an outer face and an underside parallel to each other and joined by side members, each side member constructed with a matching elliptical-shaped track, wherein a cylindrical roller of a length approximately equal to the width of said buckle outer face, is slidably movable within said track;
providing two flanges orthogonally and integrally molded on both sides of the buckle underside, each of said flanges further having an aperture;
providing an L-clamp comprising a wide member and a narrow member, said narrow member having a series of teeth protruding from its edge, wherein the wide member and narrow member being orthogonally joined together, form a junction at which two identical co-axial axles protrude from both sides of the L-clamp, the two axles of a diameter corresponding to the apertures of said L-clamp;
providing rotational leverage of said L-clamp, such that when rotated about its axes forces the teeth of the L-clamp to forcibly grip the second end of said strap, causing retention of the second end of said elastomeric strap within the L-clamp; and
placing the strap about said at least two legs, and, upon insertion of the first end of said strap between the buckle outer face and underside, moving said cylindrical roller within the confines of said track in the direction of said L-clamp, thereby exerting a frictional force against the first end of said strap, causing a resultant clamping of the first end and thereby, a firm cinching of the entirety of the elastomeric strap around the adjacent two legs of said furniture pieces.
